(19) United States
(12) Patent Application Publication
(10) Pub. No.: US 2009/0183821 A1
(43) Pub. Date: Jul. 23, 2009

(54) CONSTRAINED LAYER DAMPING SYSTEM AND METHOD OF MAKING THE SAME

(75) Inventors: Jeffrey J. Schroeder, Cleveland, OH (US); Maurice E. Wheeler, Mentor, OH (US)

Correspondence Address: Pearne & Gordon LLP, 1801 East 9th Street, Suite 1200, Cleveland, OH, 44114-3108, US

(73) Assignee: Intellectual Property Holdings, LLC, CLEVELAND, OH (US)

(21) Appl. No.: 12/358,945

(22) Filed: Jan. 23, 2009

Related U.S. Application Data
(60) Provisional application No. 61/022,925, filed on Jan. 23, 2008.

(51) Int. Cl. B32B 37/00

(52) U.S. Cl. 156/242

(57) ABSTRACT

A method of producing a constrained layer damping system including a constraining layer, a damping layer, a viscous thermally-activated decoupler (VTAD) layer and a base blank layer. The method includes the steps of blanking a constraining layer, applying a damping layer to the constraining layer to form a constraining/damping construct. A VTAD layer can be applied onto the damping layer to form a layered constraining/damping/VTAD construct in which the VTAD layer has at least one exposed surface. The exposed surface of the VTAD layer on the constraining/damping/VTAD construct is pressed onto a cleansed side of a base blank layer to form a constrained layer damping system.

This application claims the benefit of U.S. Provisional Application No. 61/022,925, filed Jan. 23, 2008, which is incorporated herein by reference in its entirety.

### FIELD OF THE INVENTION

The present invention relates to a method of preparing automobile or other panels having a constrained layer damping system, and in particular, to a method of preparing a constrained layer damping system comprising of a constraining layer, an optional damping layer, a viscous thermally-activated decoupler (VTAD) layer and a base blank layer.

### BACKGROUND

The automobile industry uses constrained layer damping systems to reduce resonant vibrations in sheet metal parts that transmit vibrations to other parts within the automobile body. Components that frequently receive damping treatment in automobiles include cowl stampings, rear wheel well stampings, floor pans and engine oil pans. Constrained layer damping systems often use a polymer layer to absorb vibrations. However, a polymer layer can become delaminated from the part being damped. For example, the vibrations generated in automobiles can contribute in the delamination of a damping layer from an automobile body panel. In another example, forming or stamping the part to be damped can contribute in the delamination of a damping layer. In the case the damping layer is applied to the part to be damped before the part is formed in its final shape, the damping layer is subject to the stresses of forming the part to be damped, such as the forces generated by stamping. The stresses of forming can damage the damping layer, which can cause the damping layer to delaminate or peel up from other layers or the part to be damped.

The present inventors have found that the use of a viscous thermally-activated decoupler (VTAD) layer can reduce or eliminate the delamination of a damping layer. Thus, it is an object of the present invention to provide a method of making such a system.

### BRIEF SUMMARY OF THE INVENTION

A method of producing a damped structure in the form of a constrained layer damping system. The method including the steps of providing a constraining layer having an upper surface and a lower surface. Applying over the lower surface of the constraining layer a damping layer to form a constraining/damping construct, wherein the damping layer is exposed on one side. A VTAD layer is applied over the exposed side of the damping layer to form a constraining/damping/VTAD construct, wherein the VTAD layer is exposed on one side. The exposed side of the VTAD layer of the constraining/damping/VTAD construct is applied over a base blank layer to form a constrained layer damping system.

A method of producing a damped structure in the form of a constrained layer damping system. The method including the steps of providing a constraining layer having an upper surface and a lower surface. Applying over the lower surface of the constraining layer a damping layer to form a constraining/damping construct, wherein the damping layer is exposed on one side. The constraining/damping construct is heated to adhere said damping layer to said constraining layer, wherein in the process of heating cures a portion of the damping layer. A VTAD layer is applied over the exposed side of the damping layer to form a constraining/damping/VTAD construct, wherein the VTAD layer is exposed on one side. The exposed side of the VTAD layer of the constraining/damping/VTAD construct is applied over a base blank layer to form a constrained layer damping system. The constrained layer damping system is cooled to ambient temperature, and then the constrained layer damping system is formed into a final shape, wherein said VTAD layer absorbs stresses generated during the forming process.

### BRIEF DESCRIPTION OF THE DRAWINGS

The following figures illustrate various aspects of one or more embodiments of the present invention, but are not intended to limit the present invention to the embodiments shown.

FIG. 1 shows an expanded cross-sectional view of a constrained layer damping system.

FIG. 2 shows an overhead view of a base blank having multiple separate constrained layer damping systems placed in varying positions on a blank base layer.

FIG. 2A shows a cross-section view of a constraining/damping/VTAD construct overlying the base blank of FIG. 2.

FIG. 3 shows an expanded cross-sectional view of a constrained layer damping system in which each primary layer is comprised of multiple secondary layers.

### DETAILED DESCRIPTION

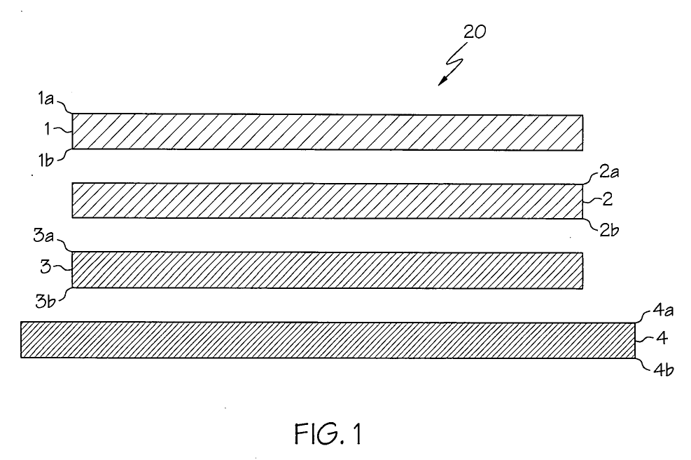

As used herein, when a range such as 5-25 is given, this means at least 5 and, separately and independently not more than 25. One embodiment of the present invention is directed to a method of making a constrained layer damping system 20, as exemplified in FIG. 1. The constrained layer damping system 20 of FIG. 1 includes a constraining layer 1, a damping layer 2, a viscous thermally-activated decoupler (VTAD) layer 3 and a base blank layer 4. The base blank layer 4 can be stamped into a final shaped part, such as an automobile part or other panel.

As shown in FIG. 1, the constraining layer 1 overlies the upper surface 2 a of the damping layer 2. The constraining layer 1, the entire layer 1 or portion thereof, can be in direct contact with the damping layer 2 and/or the VTAD layer 3. Alternatively, one or more intermediate layers, such as an adhesive, can be positioned between the constraining layer 1 and the damping layer 2 and/or VTAD layer 3. The constraining layer 1, having an upper surface 1a and a lower surface 1b, can be made of metal, non-ferrous metal, steel, stainless steel, alloys, non-metals such as plastics, or combinations thereof. The constraining layer 1 can be a high modulus material having a thickness from about 0.015 to about 0.030 inch, or about 0.005 to about 0.100 inch. The constraining layer 1 preferably has a uniform thickness. Alternatively, in one embodiment, the constraining layer 1 can be a laser sheet metal blank having varying thickness.

The initial form or shape of the constraining layer 1 can affect properties such as, for example, the stiffness of the constrained layer damping system 20 or the ability of the system to dampen various resonant frequencies for noise reduction, such as low frequency noise reduction. As such, the constraining layer 1 may be in any initial form prior to application to the constrained layer damping system. For example, the constrained layer 1 can be dimpled, rippled, or smooth. The constraining layer 1 may be in any shape or, for example, have through holes for clearance in installment. The constraining layer may be treated with a protective coating, which can prevent the layer 1 from rusting.

Optionally, the constrained layer damping system 20 can include a damping layer 2. The damping layer 2, having an upper surface 2a and a lower surface 2b, lies between the constraining layer 1 and the VTAD layer 3, such that the damping layer 2 overlies the VTAD layer 3. The damping layer 2, the entire layer 2 or portion thereof, can be in direct contact with the VTAD layer 3 and/or the constraining layer 1. Alternatively, one or more intermediate layers, such as an adhesive, can be positioned between the constraining layer 1 and the damping layer 2 or between the damping layer 2 and the VTAD layer 3. The damping layer 2 can include any material conventionally used for damping, such as a polymer material, or elastic or viscoelastic foam.

In one embodiment, the damping layer 3 can be a polymer material. The polymer material may be, but is not limited to, an emulsified acrylic and/or acrylic copolymer blend or any type of latex, a solvent acrylic system, a styrene block copolymer or vinyl acetate polymer system. The damping layer 2 can include between about 38% to about 55% resin solids in the emulsified state or about 28% to about 45% in the solvent state.

The polymer material or polymer system blend can include additives, for example, a plasticizer, a preventative, a thickening agent, a wetting agent, or combinations thereof. A plasticizer, such as dibutylphthalate, can be used to lower the glass transition temperature (T_{g}). One or more plasticizers can be used in a range from about 0.01 to about 10 weight percent, or from about 0.5 to about 2 weight percent. The polymer material or polymer system blend by itself or in combination with other additives can have an average T_{g} in the range of −10° C. to 30° C. In another example embodiment, preventatives can be added to the damping layer 2 to minimize rusting, including flash rust. Preventative material can be present in the damping layer 2 in a range from about 0.01 to about 10 weigh percent, or from about 0.5 to about 5 weight percent. One example embodiment of a preventative is a 20 to 40% solution of sodium nitrite. A thickening agent can be added to the damping layer 2 to increase in viscosity, which can aide, for example, in manufacturing or application. One or more thickening agents can be added in a range from about 0.01 to about 10 weight percent, or in a range from about 2 to about 5 weight percent. A wetting agent can be added to the damping layer 2 to assist in making a uniform coating application. One or more wetting agents can be added in a range from about 0.01 to about 10 weight percent, or about 0.5 to about 2 weight percent. Other agents may be added to the damping layer 2 depending on the requirements of the application.

The damping layer 2 can have a dry thickness of about 0.0005 to about 0.015 inch, or about 0.0001 to about 0.05 inch. The damping layer 2 preferably adheres to the constraining layer 1, and has good adhesion properties to steel. Sufficient adhesion to the constraining layer 1 can prevent separation or patch. As a measure of adhesion, the damping layer 2 can have a peel strength greater than about 25 lbs/in, and a lap shear greater than about 200 lbs/in. The damping layer material should maintain 95% of its original peel strength after 40 minutes of baking at 425° F. Table 1 provides peel strength data for a sample constrained layer damping system having a 0.030″ constraining layer, a 0.008″ damping layer, a 0.020″ VTAD layer, and a 0.030″ base blank layer baked at 425° F. for 20, 40 and 60 minutes. As a measure of damping effectiveness, the damping layer 2 can have an Oberst value above 0.1 in the temperature range of 23 to 45° C. Oberst values measured in accordance with ASTM E756/SAE J1637. Preferably, the damping layer 2 has sufficient thermal stability up to 425° F.

TABLE 1

| Baking Time @ 425° F. | Peel Strength |
|---|---|
| (min) | (lbs/0.8″) |
| 20 | 41.20 |
| 40 | 40.17 |
| 60 | 29.50 |

The constraining layer damping system 20 can include a viscous thermally-activated decoupler layer 3, or a VTAD layer 3. As described below, one method of forming or applying the constraining layer damping system 20 requires a VTAD layer. The VTAD layer 3 allows the stresses that would otherwise be imparted to the remaining layers of the constrained layer damping system 20, such as the constraining layer 1 and damping layer 2, during stamping to be dissipated primarily throughout the VTAD layer 3. By absorbing the mechanical stresses of stamping or other conventional forming methods, the VTAD layer 3 protects or shields the remaining layers of the constrained layer damping system 20 from excessive strain and stress that can cause peel up or delamination after stamping and/or during use. As described below, the VTAD layer 3 can be applied in liquid form, and after stamping, the VTAD layer 3 hardens and/or is cured. Alternatively, as described below, the VTAD layer 3 can be allowed to partially cure and/or harden after being applied to the damping layer 2 before stamping.

The VTAD layer 3 can act as a damping material and/or allow the vibrations generated in the base blank layer 4 to be damped by a another layer in the constrained layer damping system 20, such as the constraining layer 1 or damping layer 2. In other words, without the VTAD layer 3 in the constrained layer damping system 20, the stress induced during the stamping operation can cause polymers in the damping system, such as in the damping layer 2, to become damaged, for example bending beyond the polymer elastic point and/or breaking. Damage caused during stamping or similar forming process as known in the art can result the constraining layer 1 and/or damping layer 2 to delaminate or peel up in areas subjected to high stress, such as corners and deep draws.

As noted above the VTAD layer 3 can be applied in liquid form to the damping layer 2. The physical properties of the liquid, such as viscosity, can vary depending on the method used to coat the damping layer 2. Once the constraining/damping/VTAD construct is applied to the base blank layer 4, the rheology characteristics of the VTAD layer 3, and in particular during a forming or stamping operation, may contribute to the amount of stress that is dissipated and/or absorbed in the VTAD layer 3. For example, the viscosity of the VTAD layer 3 may affect the amount of stress being dissipated and/or absorbed. If the viscosity of the VTAD layer 3 is low, for example, like water at room temperature, the VTAD layer 3 will readily flow during stamping and be pressed or forced outward beyond the constrained layer damping system 20 upon bending of the base blank layer 4, thus reducing the amount of material in the VTAD layer 3 available. The amount of VTAD layer 3 material discharged from the constrained layer damping system 20 may reduce the amount of stress that the layer 3 can absorb and/or dissipate and thereby reduce the stress imparted on the damping layer 2. If enough of the VTAD layer 3 material is squeezed or forced out of the constrained layer damping system 20, the base blank layer 4 may contact the damping layer 2 during stamping. In this case, the VTAD layer 3 may ineffectively dissipate or absorb stresses generated by a stamping operation and permit at least a portion of the damping layer 2 to be directly affected by the stresses of the stamping operation.

The amount of VTAD layer 3 material being discharged from the constrained layer damping system 20 can be about less than 30, 25, 20, 15, 10, 8, 5, 4, 3, 2 or 1 percent of the total VTAD layer 3 material applied to the constraining/damping construct. The amount of VTAD layer material discharged from the constrained layer damping system 20 may be controlled by the method of applying the VTAD layer 3. For example, the VTAD layer 3 can be applied to the exposed side of the damping layer 2 so a boarder of damping layer 2 material is formed around the applied VTAD layer 3. In other words, the edges of the damping layer 2 are not covered by the applied VTAD layer 3. The VTAD layer 3 can be applied to the exposed side of the damping layer 2 such that at least about a ½ inch, ¼ inch, or ⅛ inch boarder of damping layer 2 material is created around the applied VTAD layer 3. Alternatively, a selected percentage of the surface area of the damping layer 2 can be covered by the applied VTAD layer 3. For example, the VTAD layer 3 can be applied over the exposed side of the damping layer 2 such that at least 70, 80, 90 or 95 percent of the damping layer 2 surface area is covered by the applied VTAD layer 3.

In choosing the viscosity of the VTAD layer, the viscosity of the VTAD layer 3, as applied to the exposed side of the damping layer 2 and during any subsequent forming operation, should be less than damping layer 2 the VTAD layer 3 is being applied over. The viscosity of the VTAD layer 3 material during stamping should be chosen such that significantly all, or at least the weight percentages noted above, of the VTAD layer 3 material, as applied to the constraining/damping construct, remains below the surface of the constraining/damping construct during and subsequent to a forming operation. The viscosity of the VTAD layer material during stamping should also be chosen such that the layer 3 is flexible enough to dissipate and/or absorb the stresses associated with forming. If the viscosity of the VTAD layer 3 is high, such that it behaves like a solid material, the VTAD layer 3 may crack or break apart during forming and may damage the damping layer 2 and/or reduce the amount of stress being absorbed and/or dissipated by the VTAD layer 3.

The viscosity of the VTAD layer 3 can be an inherent property of the material being used, or can be controlled by subjecting the VTAD layer 3 to various conditions. For example, the VTAD layer 3 can be cured or partially cured, either by being allowed to cure at room temperature, or being cured by an elevated temperature, perhaps by baking the VTAD layer 3.

The VTAD layer 3 can be made of any material that, at room temperature, adheres to the layers it is in directed contact with, such as a base blank layer 4 and a damping layer 2, and is capable of dissipating and/or absorbing stress. As shown in FIG. 1, the VTAD layer 3, having an upper surface 3a and a lower surface 3b, can be sandwiched between a blank base layer 4, for example made of metal, and a damping layer 2, made of one or more polymers, for example. The upper surface 3a of the VTAD layer 3, the entire surface or a portion thereof, can be in direct contact with the damping layer 2, whereas the lower surface 3b of the VTAD layer 3, the entire surface or a portion thereof, can be in direct contact with the base blank layer 4. Preferably, the VTAD layer 3 adequately adheres to the materials of these layers 2, 4. For example, polymer systems such as epoxy or crosslinked amorphous polymer systems can be used as the material for the VTAD layer 3. In one embodiment, the VTAD layer 3 can be made of Loctite 9432UA Hysol, Permabond ES550, Henkel Terkal 455B, Springfield Industries SPX-950, Resinlab EP950G. The VTAD layer can have a thickness of about 0.005 to about 0.015 inch, or about 0.001 to about 0.05 inch. The peel strength of the VTAD layer 3 can be about 5 lbs/in to about 75 lbs/in, or about 10 lbs/in to about 45 lbs/in.

In one embodiment, the VTAD layer 3 can function as the sole damping material in the constrained layer damping system 20. In such a case, a separate polymer damping layer, such as the damping layer 2 shown in FIG. 1, may not be required. As a measure of damping, using the Oberst testing method, the VTAD layer 3 measures preferably about 0.07 at 200 Hz throughout the desired temperature range, or at least above 0.2 at 200 Hz throughout the desired temperature range, such as 23 to 45° C. Oberst values measured in accordance with ASTM E756/SAE J1637.

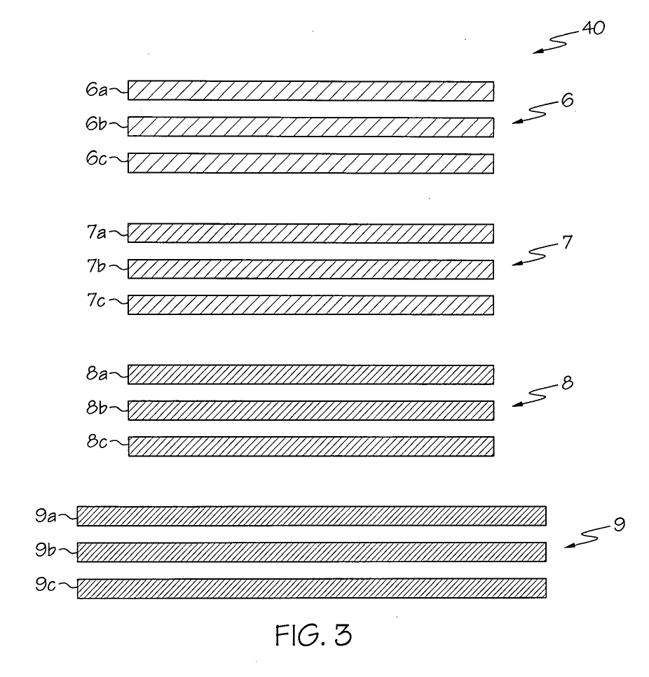

The constrained layer damping system 20 can include a base blank layer 4. The base blank layer 4, having an upper surface 4a and a lower surface 4b, can be a blank material formed in the desired shape. For example, the base blank layer 4 can be formed into and serve as an automobile or other panel to be damped. The base blank layer 4 can have a thickness of about 0.005 to about 0.1 inch, or about 0.026 to about 0.035 inch. The base blank layer 4 can be metal, non-ferrous metal, steel, stainless steel, alloys, non-metals such as plastics, or combinations thereof, and may or may not have a protective coating. Steel material may be high strength or be of the high elongation variety. It is to be appreciated that the base blank layer 4 may be any material that can be stamped or formed by conventional methods into a panel requiring damping. The base blank layer 4 may be any shape or size, such as rectangular or engineered, having a more complex shape than simply rectangular, or be laser welded to be of varying thickness. The base blank layer 4 can be a welded blank, having materials of different thicknesses welded together to form a primary layer 4 made up of multiple secondary layers as shown in FIG. 3. As with the constraining layer 1, the base blank layer 4 can have through holes at any location, for example, for ease of installment. The base blank layer 4 can be dimpled, rippled, smooth, or have other surface textures or dimensions.

A method for forming or producing a damped structure in the form of a constrained layer damping system 20 will now be described. Beginning with the constraining layer 1, a constraining layer 1 is provided having an upper and lower surface. The constraining layer 1 can be blanked if desired. Blanking can occur in any conventional manner, for example in a high blanking press at a rate of up to 1000 pieces an hour or more. As described below, blanking the constraining layer 1 can result in the surface area footprint that is smaller than the surface area footprint of the base blank layer 4. For example, the constraining layer 1 can have a surface area footprint about 90, 80, 70, 60, 50, 40, 30, 20, 10 or less percent of the base blank layer surface area footprint. The constraining layer 1, perhaps blanked, can be cleansed to remove dirt, grease, and/or residue oils. Cleansing may include one or both sides of the constraining layer 1 and may include wiping the layer 1 clean with a rag, or it may involve more stringent steps such as, for example, a phosphate cleaning system such as the kind commonly used in the automotive industry.

If used, the damping layer 2 is applied over the lower surface of the constraining layer 1. Preferably, the damping layer 2 is applied in liquid form over a cleansed side of the constraining layer 1. As applied, the damping layer is exposed on one side, the other side being in contact with the constraining layer 1 or a layer between the damping layer 2 and constraining layer 1. Application may be, for example, by spray, roll coat, extrusion, transfer from release paper, or any other conventional manner. In one embodiment, the damping layer 2 can be coated over the constraining layer 1 in a wicket oven using a reverse roll coater or a lithography line. Upon application of the damping layer 2, the constraining/damping construct is optionally heated. Heating sets or cures, at least a portion, of the damping layer 2 and/or promotes adhesion of the damping layer 2 to the constraining layer 1 if the damping layer 2 is in direct contact with the constraining layer 1, or a potion thereof. Heating can be done in any conventional manner such as, for example, in an oven or wicket oven, by induction or a heated press. Beyond heating, adhesion of the damping layer 2 can be aided by scratching a surface, or portion thereof, of the constraining layer 1 with a wire brush or a 3M abrasive wheel with balls.

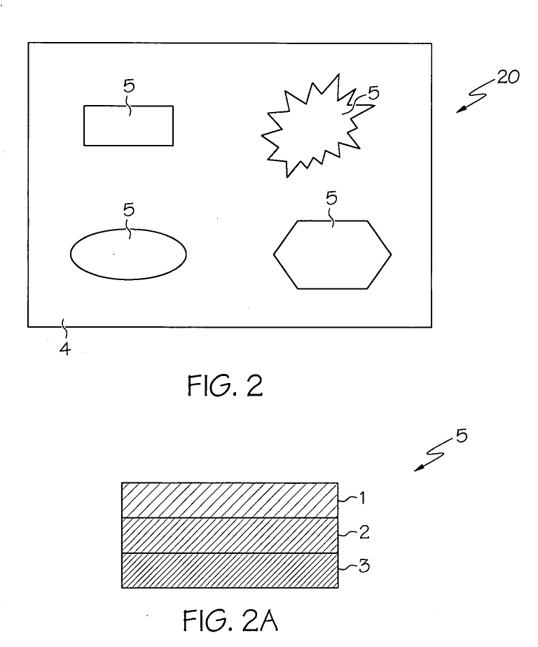

Based on the presence or non-presence of the damping layer 2, the VTAD layer 3 is applied either over the lower surface 1b of the constraining layer 1 or over the exposed side of the damping layer 2 to form a constraining/optional damping/VTAD construct 5, as shown in an in FIGS. 2 and 2A. Preferably, if the VTAD layer 3 is applied over the constraining layer 1, a cleansed surface is chosen. As applied, the VTAD layer 3 is exposed on one side, the other side being in direct contact with the damping layer 2 or a layer between the VTAD layer 3 and the damping layer 2. The method used to apply the VTAD to the constraining/damping construct can include, for example, spray, roll coat, transfer release paper or extrusion. At this point it is to be appreciated that the side of the VTAD layer opposite the side that has been applied to the construct is open to the atmosphere.

The constraining/damping/VTAD construct 5, when viewed from the top, as shown in FIG. 2, has a surface area footprint such that the constraining layer 1, damping layer 2 and VTAD layer 3 each have approximately the same surface area footprint. As shown in FIG. 2, the base blank layer 4 has a larger surface area footprint than that of the multiple constraining/damping/VTAD constructs 5 overlying the base blank layer 4. The areas of the base blank layer 4 having a constraining/damping/VTAD construct 5 directly overlying are effectively damped by the construct. That is, the constraining/damping/VTAD construct 5 is applied over the area or areas of the base blank layer 4 to be damped. Thus, if multiple areas or portions of the base blank layer 4 require damping, a constraining/damping/VTAD construct 5 can be applied over each area to be damped on the base blank layer 4. It is to be appreciated that the method of applying the constraining/damping/VTAD construct 5 may be performed in varying manners according to the needs of the situation. For example, the base blank layer 4 may be treated only where necessary or in the vibrational “hot spots”. These “hot spots” would be determined using one or more of the following methods, such as, for example, computer simulation, bench top testing, or in-situ testing. Certain areas of the base blank layer 4 of the constrained layer damping system 20 could be subject to more vibration when in use as the end product and those areas may require more damping than other areas of the base blank. As exemplified in FIG. 2, rather than place extra constraining/optional damping/VTAD construct 5 on areas of the base blank layer 4 that do not require it, the constraining/optional damping/VTAD construct 5 can be selectively placed in varying positions, as needed. Placing multiple separate constraining/optional damping/VTAD constructs 5 onto the blank base layer 4 only where they are needed will, among other things, help to save on material costs while providing efficient protection.

As with the constraining layer, the base blank layer 4 can be engineered to a specific thickness and shape if desired. After any such blanking step, the base blank can be cleansed in the areas at which a constraining/damping/VTAD construct will be attached similar to the cleansing of the constraining layer. The exposed side of the VTAD layer on the constraining/optional damping/VTAD construct is applied or pressed over a cleansed portion of the base blank layer 4 to form the constrained layer damping system 20. The pressing method may be done robotically. A pressing station may also be included to assist in adhesion. The station may also include a temporary mechanical fastening or welding station. For example, a Carver press or an equivalent can be used. The pressing pressure used can be dependent of the viscosity of the VTAD layer 3 and the temperature at which the pressing operation is conducted. For instance, a pressing pressure of 500 psi at room temperature can be used to adhere the constraining/damping/VTAD construct to the base blank layer 4. In addition to pressing, adhesion of the constraining/damping/VTAD construct can be aided by scratching a surface, or portion thereof, of the base blank layer 4 with a wire brush or a 3M abrasive wheel with balls. As applied, the constraining/damping/VTAD construct can be welded to the base blank layer 4. Such a station may be needed if robotic means for pressing are not available or as a contingency. The constrained layer damping system can then be cooled to ambient or room temperature, or about 25° C., which allows the VTAD layer 3 to cure and/or harden. For instance, if the VTAD layer 3 was heated to alter the viscosity of the layer 3 before a forming operation, the constraining/damping/VTAD construct can be cooled to return the VTAD layer 3, and possibly the constraining and damping layers if also heated, to room temperature before the forming operation. The constraining layer damping system 20 can be formed or stamped into a final desired shape, such as being stamped into an automobile or other panel part. As described above, the VTAD layer 3 absorbs or dissipates stresses generated during the forming or stamping operation.

In one embodiment, not shown, the constrained layer damping system 20 can have one or more through holes for receiving various components, such as those conventionally used in the automotive industry, for example, a rod or steering wheel column. Each layer of the constrained layer damping system 20, such as the constraining layer 1 and/or base blank layer 4, can have one or more through holes that extend entirely through the upper and lower surfaces of each layer. Each through hole present in the layers of the constrained layer damping system can be in register with each other to form a continuous through hole for receiving various components.

Further by example, often an automobile or other panel is employed to resist varying forces, such as, for example bending or torque. To form a panel that properly protects against the forces encountered during operation against which it is designed, additional materials or layers can be used to strengthen the constrained layer damping system. As shown in FIG. 3, each layer of the constrained layer damping system 40, the primary layers 6, 7, 8, 9, can be formed of multiple secondary layers that can be sandwiched and fastened together, wherein each secondary layer can have the desired properties for a specific application. The secondary layers can be secured together with known method or materials, such as by welding or with an adhesive. Any number of secondary layers can be used to form the primary layers 6, 7, 8, 9 of the constrained layer damping system 40. For example, as in FIG. 3, the constrained layer damping system 40 can include multiple constraining layers 6a, 6b, 6c, damping layers 7a, 7b, 7c, VTAD layers 8a, 8b, 8c, or base blank layers 9a, 9b, 9c. In such a case where a primary layer of the constrained layer damping system 40 is composed of multiple secondary layers, for purposes of the description above, the primary layers are referred to as if they are single layers of the system.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modification as encompassed by the scope of the appended claims.

What is claimed is:

1. A method of producing a damped structure in the form of a constrained layer damping system, said method comprising the steps of:
providing a constraining layer having an upper surface and a lower surface;
applying over said lower surface of said constraining layer a damping layer to form a constraining/damping construct, said damping layer being exposed on one side;
applying a VTAD layer over said exposed side of said damping layer to form a constraining/damping/VTAD construct, said VTAD layer being exposed on one side;
applying said exposed side of said VTAD layer of said constraining/damping/VTAD construct over a base blank layer to form a constrained layer damping system.

2. The method of claim 1, further comprising cooling said constrained layer damping system to room temperature.

3. The method of claim 1, further comprising forming said constrained layer damping system into a final shape.

4. The method of claim 3, said final shape being formed by a stamping operation.

5. The method of claim 3, further comprising choosing the viscosity of said VTAD layer such that less than 30 weight percent of the material of said VTAD layer is discharged from said constrained layer damping system during said forming.

6. The method of claim 3, wherein the viscosity of said VTAD layer during said forming allows less than 30 weight percent of the material of said VTAD layer to be discharged from said constrained layer damping system.

7. The method of claim 3, said final shape of said constrained layer damping system having at least 90 weight percent of said applied VTAD layer.

8. The method of claim 3, said final shape being an automobile part.

9. The method of claim 1, applying said constraining/damping/VTAD construct on the area of said base blank layer to be damped.

10. The method of claim 9, said constraining/damping/VTAD construct having a surface area footprint smaller than the surface area of the base blank layer such that a portion of the base blank layer is damped by said constraining/damping/VTAD construct.

11. The method of claim 9, said base blank layer having multiple constraining/damping/VTAD constructs overlying a surface of said base blank layer.

12. The method of claim 1, said base blank layer having a through hole extending through the upper and lower surfaces of said base blank layer.

13. The method of claim 12, said constraining layer having a through hole extending through the upper and lower surfaces of said constraining layer.

14. The method of claim 13, said through hole of said base blank layer being in register with said through hole of said constraining layer.

15. The method of claim 1, further comprising welding said constraining/damping/VTAD construct to said base blank layer.

16. The method of claim 1, further comprising blanking the constraining layer and cleaning the constraining layer prior to applying said damping layer.

17. The method of claim 16, said blanking resulting in said constraining layer having a smaller surface area footprint than that of said base blank layer.

18. The method of claim 1, further comprising heating said damping layer after applying said damping layer over the lower surface of said constraining layer.

19. The method of claim 18, said damping layer being applied in liquid form.

20. The method of claim 18, wherein said heating promotes adhesion of the damping layer to the constraining layer.

21. The method of claim 17, wherein said heating partially cures a portion of said damping layer.

22. The method of claim 1, said VTAD layer being in direct contact with a portion of the base blank layer.

23. The method of claim 1, said VTAD layer being in direct contact with a portion of the damping layer.

24. The method of claim 1, said VTAD layer being composed of a polymer.

25. The method of claim 1, said VTAD layer being heated before applying said exposed side of said VTAD layer of said constraining/damping/VTAD construct over a base blank layer to form a constrained layer damping system.

26. The method of claim 1, said VTAD layer being applied to said exposed side of said damping layer such that at least a 0.125-inch boarder of damping material exists around said applied VTAD layer.

27. The method of claim 1, said VTAD layer covering not more than 90 percent of the surface area of said damping layer.

28. A method of producing a damped structure in the form of a constrained layer damping system, said method comprising the steps of:
providing a constraining layer having an upper surface and a lower surface;
applying a damping layer directly onto the lower surface of the constraining layer to form a constraining/damping construct, said damping layer being exposed on one side;
heating said constraining/damping construct to adhere said damping layer to said constraining layer, wherein in said heating cures a portion of the damping layer;
applying a VTAD layer directly onto said exposed side of said damping layer to form a constraining/damping/VTAD construct, said VTAD layer being exposed on one side;
applying said exposed side of said VTAD layer of said constraining/damping/VTAD construct directly onto a base blank layer to form a constrained layer damping system;
cooling said constrained layer damping system to ambient temperature;
forming said constrained layer damping system into a final shape, wherein said VTAD layer absorbs stresses generated during said forming.
